(19) United States
(12) Patent Application Publication
(10) Pub. No.: US 2020/0118403 A1
(43) Pub. Date: Apr. 16, 2020

(54) BUILDING EVACUATION SUPPORT TOOL

(71) Applicant: CARRIER KALTETECHNIK DEUTSCHLAND GMBH, Koln (DE)

(72) Inventors: Hector Moner Poy, Cork (IE); Brian Duffy, Newcastle, Co. Wicklow (IE); Philip J. Harris, Cork (IE); Menouer Boubekeur, Cork (IE); Szymon Fedor, Cambridge, MA (US)

(21) Appl. No.: 16/489,267

(22) PCT Filed: Mar. 2, 2018
(86) PCT No.: PCT/US2018/020657

§ 371 Date: Aug. 27, 2019

Related U.S. Application Data
(60) Provisional application No. 62/466,145, filed on Mar. 2, 2017.

(51) Int. Cl. G08B 7/06; G08B 17/06; H04W 4/33; H04W 4/024; G01C 21/20

(52) U.S. Cl. CPC G08B 7/066; G08B 17/06; G01C 21/206; H04W 4/024; H04W 4/33

(57) ABSTRACT

A tool for supporting fire wardens during a building evacuation event is provided. The tool includes a mobile computing device comprising a display unit, a memory and a processor. The memory has executable instructions of an application stored thereon, which, when executed, cause the processor to interface with monitoring and control systems of a building and to control the display unit to display an interactive floor plan of the building with scene selection capability, to display evacuation, evacuation re-routing and action guidance overlaid on the interactive floor plan and to display real-time monitoring and building control options overlaid on the interactive floor plan.

The work leading to this invention has received funding from the European Union Seventh Framework Programme (FP7/2007-2013) under grant agreement no. 288079.

### BACKGROUND

The following description relates to tools for supporting fire wardens and, more particularly, to tools for supporting fire wardens during building evacuation events.

Building management is becoming both increasingly sophisticated and more reliant on automation. Structures are regularly fitted with many sensors and controllers that send vast amounts of data to building automation systems (BASs). Traditionally, monitoring and control systems for energy management, security and safety coexist as separate subsystems with little cooperation between them. However, demand for more robust and interoperable systems is increasing because these systems result in more optimal and effective deployments of equipment, thereby reducing the number of required devices, energy consumption and cost.

A project has therefore been developed to implement a building management framework and provide services and tools to support distributed, energy-aware, and cooperative monitoring and control systems. One element of the framework implements a cloud-based service for building evacuation during a fire emergency.

Fire is one of the most common emergency events for a building. It can spread rapidly, burn intensely, carry strong heat and produce large volumes of fumes and smoke. Fire can prevent evacuees from escaping buildings by obstructing exits and can inflict casualties and cause loss of life. For early fire detection and suppression, building standards require installation of fire alarms, smoke detectors, carbon monoxide detectors and firefighting equipment, such as extinguishers, fire blankets and sprinkler systems. Standard fire safety systems are connected to a central panel that triggers the alarm and provides status information while alarm systems including strobe lights, lighted exit signs and sirens alert occupants and guide them to the nearest exit.

In addition to fire safety systems, commercial and public buildings often have fire wardens on hand to coordinate building evacuation processes in the event of a fire by assisting evacuees, using firefighting and suppression equipment and relaying information to first responders. Fire wardens are typically volunteers or persons employed in a building for a specific purpose and are often tasked with fighting small fires with extinguishers or blankets, guiding people to building exits quickly, monitoring evacuees' health and conditions, identifying the fire locations to first responders and identifying vulnerable evacuees to first responders. How these actions are executed tends to have a huge impact on how the evacuation proceeds and the emergency event's ultimate outcome. Thus, to be effective, fire wardens need information (e.g., fire location, status of egress routes, additional hazards and disabled or injured people in their designated area) and communications capabilities.

### BRIEF DESCRIPTION

According to one aspect of the disclosure, a tool for supporting fire wardens during a building evacuation event is provided. The tool includes a mobile computing device that includes a display unit, a memory and a processor. The memory has executable instructions of an application stored thereon, which, when executed, cause the processor to interface with monitoring and control systems of a building and to control the display unit to display an interactive floor plan of the building with scene selection capability, to display evacuation, evacuation re-routing and action guidance overlaid on the interactive floor plan and to display real-time monitoring and building control options overlaid on the interactive floor plan.

In accordance with additional or alternative embodiments, the scene selection capability includes an option to display and select cleared areas, an option to display and deselect blocked evacuation routes and an option to display and provide assistance to locations of trapped or injured individuals.

In accordance with additional or alternative embodiments, the evacuation, the evacuation re-routing and the action guidance is static or dynamic and based at least partially on emergency event parameters.

In accordance with additional or alternative embodiments, the evacuation, the evacuation re-routing and the action guidance includes logging capabilities that are displayable by the display unit for interaction with a user.

In accordance with additional or alternative embodiments, the real-time monitoring and building control options comprise evacuation status displays, smoke and hazardous fume level information displays, fire evolution displays, individual location displays and information provided from human-in-the-loop interfaces.

In accordance with additional or alternative embodiments, the tool is communicatively coupled with the monitoring and control systems.

In accordance with another aspect of the disclosure, a tool for supporting fire wardens during a building evacuation event is provided. The tool includes a mobile computing device that includes a display unit, a memory and a processor. The memory has executable instructions of an application stored thereon, which, when executed, cause the processor to interface with monitoring and control systems of a building and to control the display unit to display an interactive floor plan of the building with scene selection capability, to display evacuation, evacuation re-routing and action guidance overlaid on the interactive floor plan and to display real-time monitoring and building control options overlaid on the interactive floor plan. The real time monitoring and building control options include at least one of manual and automatic adaptive control of a heating and air conditioning (HVAC) system of the building.

In accordance with additional or alternative embodiments, the scene selection capability comprises an option to display and select cleared areas, an option to display and deselect blocked evacuation routes and an option to display and provide assistance to locations of trapped or injured individuals.

In accordance with additional or alternative embodiments, the evacuation, the evacuation re-routing and the action guidance is static or dynamic and based at least partially on emergency event parameters.

In accordance with additional or alternative embodiments, the evacuation, the evacuation re-routing and the action guidance includes logging capabilities that are displayable by the display unit for interaction with a user.

In accordance with additional or alternative embodiments, the at least one of the manual and automatic adaptive control of the HVAC system includes fresh air insertion and exhaustion controls.

In accordance with additional or alternative embodiments, the automatic adaptive control of the HVAC system is executed by the processor and includes an analysis of parameters of an emergency event, a determination of a strategy for handling the emergency event based on a result of the analysis and an execution of the determined strategy.

In accordance with additional or alternative embodiments, the real-time monitoring and building control options comprise evacuation status displays, smoke and hazardous fume level information displays, fire evolution displays, individual location displays and information provided from human-in-the-loop interfaces.

In accordance with additional or alternative embodiments, the real-time monitoring and building control options further include emergency light controls and door lock controls.

According to yet another aspect of the disclosure, a tool for supporting fire wardens during a building evacuation event is provided. The tool includes an elevator dispatch system and a mobile computing device. The elevator dispatch system includes one or more elevator systems, a first memory and a first processor. The mobile computing device includes a display unit, a second memory and a second processor. The second memory has executable instructions of an application stored thereon, which, when executed, cause the second processor to control the display unit to display an interface for communicating with and controlling the elevator dispatch system and to communicate with and control the elevator dispatch system in accordance with commands entered into the interface. The first memory has executable instructions stored thereon, which, when executed, cause the first processor to control the one or more elevator systems in accordance with communications and controls received from the second processor.

In accordance with additional or alternative embodiments, the second processor communicates with the elevator dispatch system directly or via a building management system.

In accordance with additional or alternative embodiments, the communications received from the second processor include information relating to individuals being evacuated and information relating to a prioritization of the individuals.

In accordance with additional or alternative embodiments, the controls received from the second processor include requests to avoid transporting individuals to certain floors.

In accordance with additional or alternative embodiments, when executed, the executable instructions stored on the first memory cause the first processor to determine which of the one or more elevator systems will be used to transport certain individuals to certain locations and to display the determination within the interface.

These and other advantages and features will become more apparent from the following description taken in conjunction with the drawings.

### BRIEF DESCRIPTION OF THE DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a schematic illustration of a building automation architecture in accordance with embodiments;

FIG. 2 is a flow diagram illustrating a building evacuation workflow in accordance with embodiments;

FIG. 3 is a series of screenshots of a rescue worker interface in accordance with embodiments;

FIG. 4 is an image of a tool for supporting fire wardens during an emergency event in accordance with embodiments:

FIG. 5 is a schematic illustration of the tool of FIG. 4 deployed in a building; and

FIG. 6 is an image of a tool for supporting fire wardens during an emergency event in accordance with embodiments.

### DETAILED DESCRIPTION

As will be described below, a rescue worker interface (RWI) and a cloud-based service and mobile application are provided to leverage a building automation framework to access building automation systems (BASs) and to provide real-time monitoring and control capabilities in a clear, holistic and unified view of an emergency to thereby increase contextual and situational awareness of fire wardens. The RWI also provides additional features to assist communications, coordination, decision making and management of building evacuations. That is, the RWI and the cloud-based service are provided with access to BASs and serve to assist fire wardens during emergency events and building evacuation processes.

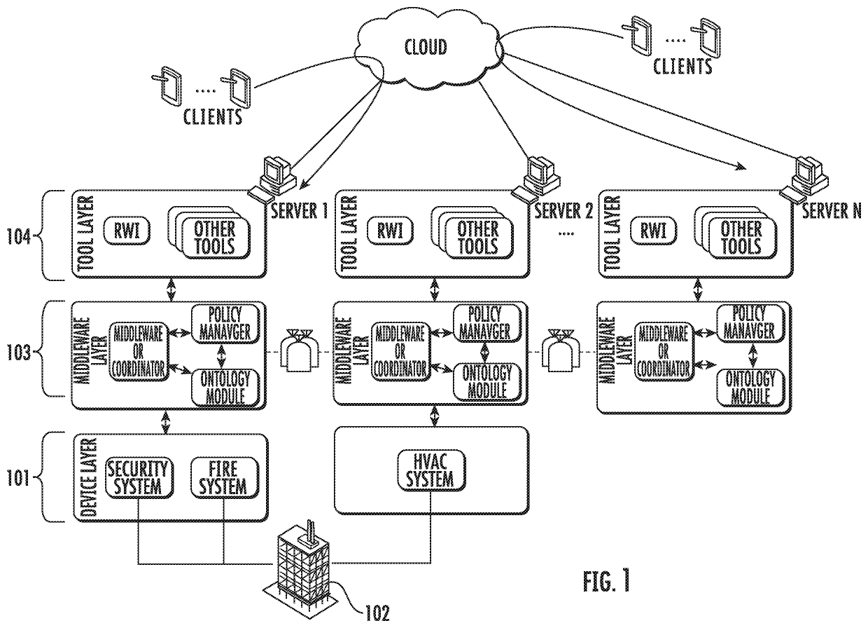

With reference to FIG. 1, a building automation framework or some other type of framework or application is provided as a high-level architecture with at least three or more layers. Inside each layer, building managers can add different modules based on a service-oriented architecture to provide required capabilities, services and functionalities. The device layer 101 includes heterogeneous technology modules that control sensors and actuators deployed in the building 102. These modules provide for monitoring and control capabilities in the building 102. All of the devices are exposed in the middleware layer 103 which enables self-organization and cooperation among building systems.

The middleware layer 103 may include a coordinator module that acts as a gateway between technologies, providing a uniform abstraction layer on top of the various software and hardware components, enacts coordination rules and binds devices according to the directives. These directives may be provided by the policy manager (PM), which may monitor systems, detect events and automatically adapt system operation strategies and configurations accordingly. An ontology module may be included to provide additional information relevant to evacuation, such as information about buildings and building components, their properties, and the relationships between them, more specifically including, for example, building automation designs, system requirements, and information about installed devices (such as addresses, channels, locations, etc.).

The tool layer 104 includes multiple user application and service modules (e.g., the RWI) that can interface with the middleware layer 103 modules to access services and data. The tool layer 104 can be a collection of cloud-based services characterized by their specific functionalities and their access to the BASs. The RWI is an example of these services because it supports building egress using cloud computing to generate effective and reduced emergency descriptors.

That is, the RWI leverages BASs and puts them in the hands of fire wardens in the form of an application running on a portable computing device or a smart mobile device. The mobile device connects wirelessly to the cloud, retrieves evacuation data, transmits fire wardens' information, such as location or building control commands, and visualizes the relevant evacuation information and notifications on interactive floorplans, translating the information in summary format using, for example, icons, glyphs, annotations, links or other summary visual or textual information. Management and dissemination of this information requires some cloud processing, data filtering and aggregation to display it concisely in the mobile application in order to increase each fire warden's effectiveness in the event of an emergency, particularly their communication and coordination capacity, and their ability to react to unexpected circumstances, convey information to emergency services and reduce the overall egress time and uncertainty about the possibility that the building isn't completely evacuated.

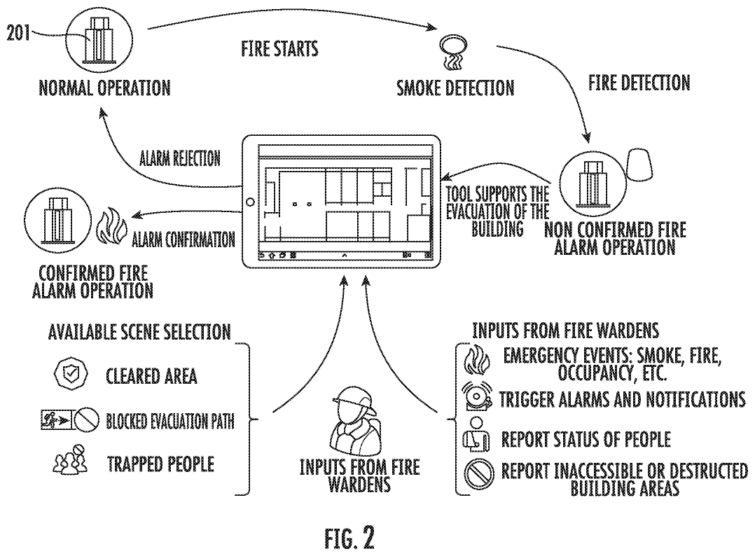

With reference to the exemplary event flow demonstrated in FIG. 2, a building 201 is provided and assumed at first to be operating in a normal mode. At some later time, a fire is detected and an alarm is triggered in accordance with rules set by the PM, as described above. Next, the building 201 moves into emergency mode, causing the BASs to be automatically reconfigured to facilitate egress. Fire wardens, equipped with a smart device running the RWI application, proceed to evacuate the building. When the emergency event ends, the building 201 switches back to its normal configuration.

In accordance with embodiments, the RWI includes at least two or more subsystems: the RWI object located in the tool layer 101 and the RWI application running on the smart mobile device. Fire wardens can use the RWI application's GUI to monitor and control the BASs in real time through an interactive building floorplan. This floorplan is a scalable vector graphics (SVG) file including data structures that are parsed by the RWI application to display controls and floor or room status information according to data retrieved from the RWI object. Textual information may also be displayed. The RWI object, running in the cloud for example, monitors and controls deployed sensors and actuators and also provides fire warden tracking, duplex information streaming, system notifications and automatic dissemination of annotations.

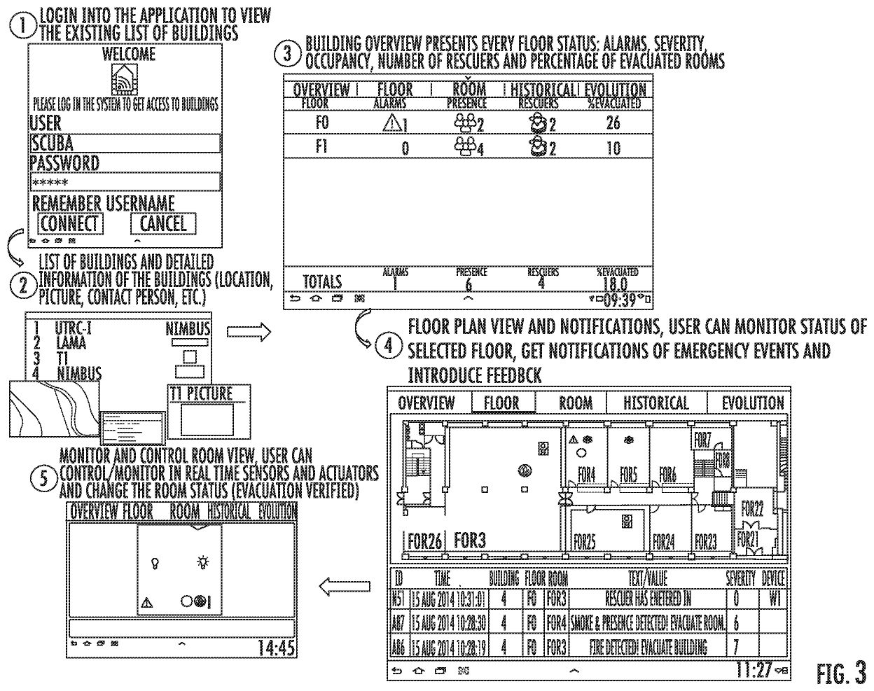

With reference to FIG. 3, an exemplary usage overview of the RWI application is provided to demonstrate an embodiment of a user interface used by fire wardens or other personnel to monitor and control the BASs in real time. During an emergency event, fire wardens, equipped with a mobile device with cloud connectivity, may execute the RWI application and log in as a user. Once authenticated, various actions may be taken or information selected for display. For example, the user can see a list of serviced buildings and can access additional information, such as the building manager's contact details or a map by, for example, long pressing the building of interest. After the user selects the building of interest, the RWI application presents a floor status overview. In this view, rescuers may see various information relevant to the status of a room, a section, a floor and/or the building, such as the active alarms on each floor, their severity (which may be coded as a background color), the number of people (which may include evacuees and rescue personnel), the number of rooms in which people are detected, the number and location of fire wardens and the percentage of the building that's been evacuated (per floor and overall). This summary helps users identify the areas requiring the most urgent attention. The view is automatically updated to provide real-time information.

A corresponding floor view appears when, for example, the user presses one of the floors. Here, users may obtain a generic view in real-time about the emergency status of all the rooms in the selected floor, evacuated rooms and the locations of fire, smoke alarms, evacuees and other fire wardens. The view may also include a dedicated area for notifications and alarms, which increases rescuers' contextual awareness by providing event details such as triggering time, severity, location, and type. The floorplan may be interactive, for example, may let the user zoom in/out, drag and/or press. In one example, to access room views users press one of the rooms, and the resulting view presents the same information shown in the floor view plus the status of the sensors and actuators installed in that room. Multiple actions may be taken in views, for example, fire wardens may control lights in the room, and after checking for evacuees, may mark the room as evacuated by pressing the room background. After evacuation is complete, or if other new information is updated, a new evacuation status may be disseminated to all other fire wardens.

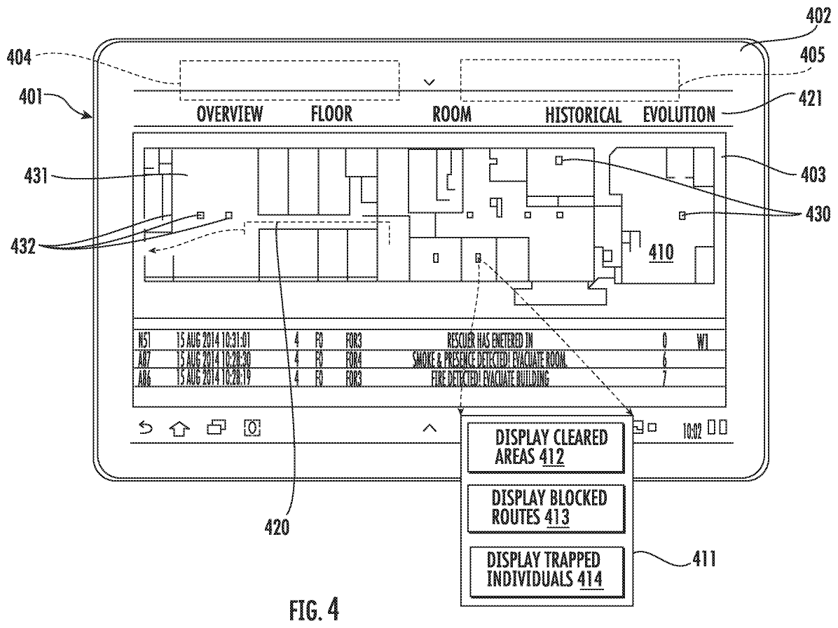

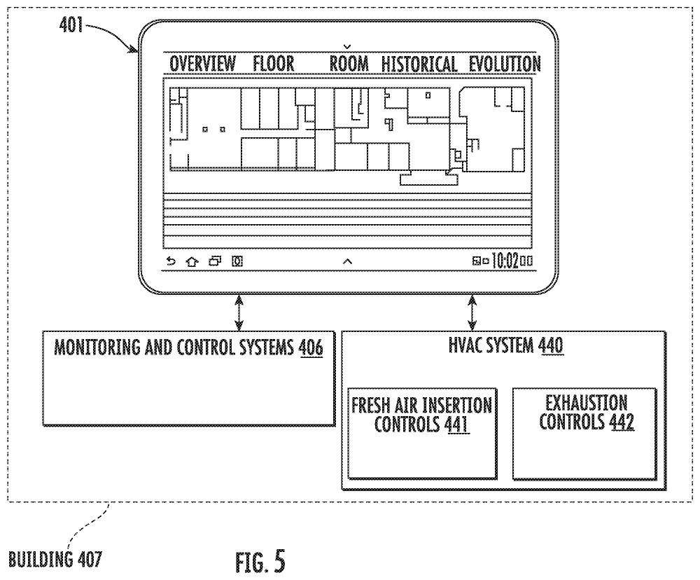

With the above in mind and with reference to FIGS. 4 and 5, a tool 401 is provided for supporting fire wardens during a building evacuation event. The tool 401 includes a mobile computing device 402. The mobile computing device 402 includes a display unit 403, a memory 404 and a processor 405. The memory 404 may be provided with read-only memory (ROM) and random access memory (RAM), for example, and has executable instructions of an application (e.g., the RWI application described above) stored thereon. When executed, these executable instructions cause the processor 405 to interface with monitoring and control systems 406 (see FIG. 5) of a building 407 (see FIG. 5) in which the tool 401 is deployed. When executed, the executable instructions also cause the processor 405 to control the display unit 403 to display an interactive floor plan 410 of the building with scene selection capability 411, static or dynamic evacuation, evacuation re-routing and action guidance 420 that is based on emergency event parameters and is overlaid on the interactive floor plan 410 as well as real-time monitoring and building control options 430 that are overlaid on the interactive floor plan 410.

In addition, the executable instructions may cause the processor 405 to enable “human-in-the-loop” capabilities. Such “human-in-the-loop” capabilities provide the tool 401 with an interface that allows fire wardens to enhance information collected by mechanical sensors (by, for example, becoming “human sensors”) and to add their sensing capabilities to the inputs to the overall system whereby the fire wardens can verify or cancel events already detected (smoke, fire, presence of individuals in certain places within or outside of the building 407, etc.), or introduce new events that cannot be automatically and/or mechanically sensed but are relevant to the evacuation task. For example, users such as fire wardens can input into the system the severity of an event, status of evacuees, inaccessible or destructed building zones, and/or vulnerable and trapped evacuees.

Selection of interactive elements may provide additional information depending on context, and specific context may be selectively identified for display by a user. For example, the scene selection capability 411 may be engaged by the user clicking on a floor, hallway or room of the interactive floor plan 411 and may include an option to display cleared areas 412, an option to display blocked evacuation routes 413 and an option to display locations of trapped individuals 414 and then to apply predefined control rules based on those eventualities to a given scene. Here, term “scene” refers to an identifier or tag that includes a group of control rules and actions and allows fire wardens, depending on how an evacuation proceeds, to select the most suitable scene among a previously set of defined scenes and as a result enact control rules for executing embedded actions. The evacuation, the evacuation re-routing and the action guidance 420 may include logging capabilities 421 that allow the user to identify which evacuees are safe and which are not and to identify how long it took for those evacuees to be saved. The real-time monitoring and building control options 430 may include evacuation status displays, smoke and hazardous fume level information displays, fire evolution displays and individual location displays 431 as well as emergency light and door lock controls 432.

In accordance with further embodiments, the real time monitoring and building control options 430 may include at least one of manual and automatic adaptive control of a heating and air conditioning (HVAC) system 440 of the building 407. Such manual and automatic adaptive control of the HVAC system 440 (see FIG. 5) may include fresh air insertion controls 441 and exhaustion controls 442 (see FIG. 5) so that any one particular region within the building 407 can have fresh air or oxygen pumped into it in order to provide breathable air to individuals located in those regions or so that oxygen can be removed from other regions in order to suppress fires. In any case, the automatic adaptive control of the HVAC system may be executed by the processor 405 and includes an analysis of parameters of an emergency event, a determination of a strategy for handling the emergency event based on a result of the analysis and an execution of the determined strategy.

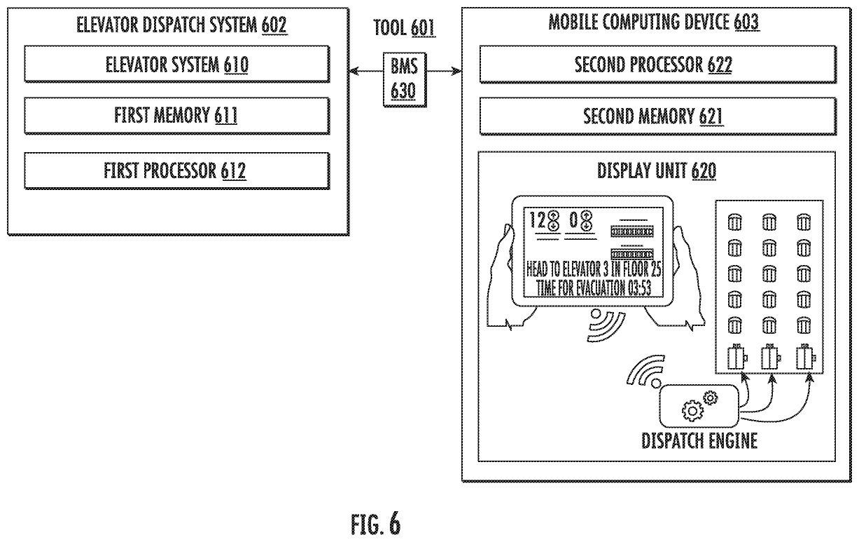

With reference to FIG. 6, a tool 601 for supporting fire wardens during a building evacuation event is provided. The tool 601 includes an elevator dispatch system 602 and a mobile computing device 603. The elevator dispatch system 602 includes one or more elevator systems 610, a first memory 611 and a first processor 612 and the mobile computing device 603 includes a display unit 620, a second memory 621 and a second processor 622. The second memory 621 may be provided with ROM and RAM, for example, and has executable instructions of an application (e.g., the RWI application described above) stored thereon. When executed, these executable instructions cause the second processor 622 to control the display unit 620 to display an interface for communicating with and controlling the elevator dispatch system 602 and to communicate with and control the elevator dispatch system 602 in accordance with commands entered into the interface. The first memory 611 may be provided with ROM and RAM, for example, and has executable instructions stored thereon. When executed, these executable instructions cause the first processor 612 to control the one or more elevator systems 610 in accordance with communications and controls received from the second processor 622 directly or via a building management system (BMS) 630.

In accordance with embodiments, the communications received from the second processor 622 may include information relating to individuals being evacuated and information relating to a prioritization of those or other individuals. Meanwhile, the controls received from the second processor 622 may include requests to avoid transporting individuals to certain floors. In any case, when they are executed, the executable instructions stored on the first memory 611 cause the first processor 612 to determine which of the one or more elevator systems 610 will be used to transport certain individuals to certain locations and to command the second processor 622 to cause the display unit 620 to display the determination of the first processor 612 within the interface.

Thus, the tool 601 provides for decision making about which elevators in a given elevator system should be used to evacuate corresponding groups of evacuees. Requests from suitably-equipped fire wardens (via implicit or explicit authorization credentials) are prioritized while restrictions on elevator usage by normal occupants are maintained. The tool 601 will further provide for the display of the decisions to the fire wardens and advise them as to whether and how evacuations will occur. Fire wardens will also be informed about the expected waiting time for an elevator and, as a result, fire wardens will be able to direct occupants to most appropriate elevator shafts.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A tool for supporting fire wardens during a building evacuation event, the tool comprising:
a mobile computing device comprising a display unit, a memory and a processor,
the memory having executable instructions of an application stored thereon, which, when executed, cause the processor to interface with monitoring and control systems of a building and to control the display unit to display:
an interactive floor plan of the building with scene selection capability, evacuation, evacuation re-routing and action guidance overlaid on the interactive floor plan, and
real-time monitoring and building control options overlaid on the interactive floor plan.

2. The tool according to claim 1, wherein the scene selection capability comprises an option to display and select cleared areas, an option to display and deselect blocked evacuation routes and an option to display and provide assistance to locations of trapped or injured individuals.

3. The tool according to claim 1, wherein the evacuation, the evacuation re-routing and the action guidance is static or dynamic and based at least partially on emergency event parameters.

4. The tool according to claim 1, wherein the evacuation, the evacuation re-routing and the action guidance comprises logging capabilities that are displayable by the display unit for interaction with a user.

5. The tool according to claim 1, wherein the real-time monitoring and building control options comprise evacuation status displays, smoke and hazardous fume level information displays, fire evolution displays, individual location displays and information provided from human-in-the-loop interfaces.

6. The tool according to claim 1, wherein the real-time monitoring and building control options comprise emergency light controls and door lock controls.

7. The tool according to claim 1, wherein the tool is communicatively coupled with the monitoring and control systems.

8. A tool for supporting fire wardens during a building evacuation event, the tool comprising:
a mobile computing device comprising a display unit, a memory and a processor,
the memory having executable instructions of an application stored thereon, which, when executed, cause the processor to interface with monitoring and control systems of a building and to control the display unit to display:
an interactive floor plan of the building with scene selection capability,
evacuation, evacuation re-routing and action guidance overlaid on the interactive floor plan, and
real-time monitoring and building control options overlaid on the interactive floor plan,
the real time monitoring and building control options comprising at least one of manual and automatic adaptive control of a heating and air conditioning (HVAC) system of the building.

9. The tool according to claim 8, wherein the scene selection capability comprises an option to display and select cleared areas, an option to display and deselect blocked evacuation routes and an option to display and provide assistance to locations of trapped or injured individuals.

10. The tool according to claim 8, wherein the evacuation, the evacuation re-routing and the action guidance is static or dynamic and based at least partially on emergency event parameters.

11. The tool according to claim 8, wherein the evacuation, the evacuation re-routing and the action guidance comprises logging capabilities that are displayable by the display unit for interaction with a user.

12. The tool according to claim 8, wherein the at least one of the manual and automatic adaptive control of the HVAC system comprises fresh air insertion and exhaustion controls.

13. The tool according to claim 8, wherein the automatic adaptive control of the HVAC system is executed by the processor and comprises:
an analysis of parameters of an emergency event;
a determination of a strategy for handling the emergency event based on a result of the analysis; and
an execution of the determined strategy.

14. The tool according to claim 8, wherein the real-time monitoring and building control options comprise evacuation status displays, smoke and hazardous fume level information displays, fire evolution displays, individual location displays and information provided from human-in-the-loop interfaces.

15. The tool according to claim 8, wherein the real-time monitoring and building control options further comprise emergency light controls and door lock controls.

16. A tool for supporting fire wardens during a building evacuation event, the tool comprising:
an elevator dispatch system comprising one or more elevator systems, a first memory and a first processor; and
a mobile computing device comprising a display unit, a second memory and a second processor,
the second memory having executable instructions of an application stored thereon, which, when executed, cause the second processor to control the display unit to display an interface for communicating with and controlling the elevator dispatch system and to communicate with and control the elevator dispatch system in accordance with commands entered into the interface, and
the first memory having executable instructions stored thereon, which, when executed, cause the first processor to control the one or more elevator systems in accordance with communications and controls received from the second processor.

17. The tool according to claim 16, wherein the second processor communicates with the elevator dispatch system directly or via a building management system.

18. The tool according to claim 16, wherein the communications received from the second processor comprise:
information relating to individuals being evacuated; and
information relating to a prioritization of the individuals.

19. The tool according to claim 16, wherein the controls received from the second processor comprise requests to avoid transporting individuals to certain floors.

20. The tool according to claim 16, wherein, when executed, the executable instructions stored on the first memory cause the first processor to determine which of the one or more elevator systems will be used to transport certain individuals to certain locations and to display the determination within the interface.
